(19) United States
(12) Patent Application Publication
(10) Pub. No.: US 2002/0045442 A1
(43) Pub. Date: Apr. 18, 2002

(54) Method and telecommunications network for controlling an external device

(76) Inventors: Lars Silen, Esbo (FI); Jussi Saksa, Espoo (FI)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/978,526

(22) Filed: Oct. 16, 2001

(30) Foreign Application Priority Data
Oct. 17, 2000 (GB) 0025389.8

(51) Int. Cl. H04M 3/00

(52) U.S. Cl. 455/420; 455/466; 455/414; 455/557

(57) ABSTRACT

In order to control an external device 3, which may be associated with or remote from a terminal such as a mobile telephone 2, the terminal 2 sends a control request, for example in the form of an SMS message, to a telecommunications network 1. The network 1 converts the request into a control code which is in a form ready for controlling the external device 3. The control code is embedded in an SMS message which is then transmitted from the network 1 to the device 3, which has a GSM or other module associated with it in order to allow the embedded control code to be received, extracted, and supplied to the device 3 to perform the requested operation or function.

The present invention relates to a method of controlling an external device. The present invention also relates to a telecommunications network for performing such a method.

WO 09956447A discloses a technique for permitting automatic configuring of network appliances such as internet-compatible telephones. An HTML page is accessed using a browser application and data from the page is downloaded. The HTML code is parsed so as to identify configuration information, which is transmitted to a telephone. The telephone is thus configured in accordance with this information by a user who does not need to make use of any programming languages.

U.S. Pat. No. 5,875,242 discloses a system for controlling and updating telecommunications devices such as exchanges. A local database within the system provides real-time or near real-time access and modification of programming information for the telecommunications equipment. Individual items of equipment can have their program information updated from the system which may thus provide a single or central control point for various items of telecommunications equipment.

U.S. Pat. No. 6,047,071 discloses a technique which allows updating of system parameters of a mobile phone. In particular, when the mobile telephone parameters are to be updated, a secure communication link to a telecommunications network is established to allow updated parameter values to be transmitted to the mobile phone and stored therein for future use.

Mobile phones are known which allow text messages to be transmitted and received. For example, in the case of GSM mobile telephones, text messages may be sent by a communication link which is distinct from the link provided for voice or speech communication. Such messages are known as SMS messages and are defined within the GSM standard.

According to a first aspect of the invention, there is provided a method of controlling an external device, comprising the steps of:

sending a control request from a terminal to a telecommunications network;

converting the request into a control code; and

sending the control code from the telecommunications network to the external device.

The terminal may be a mobile wireless terminal such as a cellular telephone or communicator. The control request may be sent from the terminal to the telecommunications network using a text messaging service.

Preferably, the control code is sent from the telecommunications network to the external device using a text messaging service. Text messaging may be used over a whole or a part of the transmission path. Alternatively, the control code may be sent to the external device using e-mail or a web or WAP download.

The external device may be associated with or may form part of the terminal. For example, the terminal may be coupled to the external device via a local wireless link, e.g. Bluetooth or infra-red. Alternatively, the external device may be remote from the terminal. The external device may have a telecommunications receiver, e.g. a wireless data card.

The step of sending a control request may comprise dialling a service telephone number of the telecommunications network.

The control request may include an identifier identifying the terminal. The destination of the control code may be determined by the identifier.

The telecommunications network may interact with the terminal to select one of a plurality of predetermined control codes for sending to the external device. The interaction may be at least partly via a speech channel or may use the Wireless Application Protocol.

In response to receipt of the control code, the external device may send, or cause to be sent, a response comprising at least part of a text message to the telecommunications network. The telecommunications network may send at least part of the response as at least part of a further text message to the terminal.

According to a second aspect of the invention, there is provided a telecommunications network for performing a method according to the first aspect of the invention. According to a third aspect of the invention, there is provided a telecommunications network comprising means for converting a control request from a terminal to a control code and means for sending the control code to an external device for controlling the external device.

The network may comprise a computer.

According to a fourth aspect of the invention, there is provided a program for controlling a computer of a network according to the second or third aspect of the invention.

According to a fifth aspect of the invention, there is provided a medium containing a program according to the fourth aspect of the invention.

It is thus possible to provide a reliable and convenient way of controlling an external device via a telecommunications network from a terminal, such as a mobile telephone (or communicator or PDA having a wireless telephone capability) or other type of telephone. In the case of a mobile telephone, for example, it is unnecessary to store any control codes in the telephone, which may comprise sequences of commands and which would otherwise occupy substantial amounts of memory. Although it would be possible to convert control requests to control codes within such a mobile telephone, this would require significant amounts of processing power and memory within the mobile telephone. Instead, relatively simply control requests may be sent to the telecommunications network. For example, it may be necessary merely to send a service number to the telecommunications network. Where a choice of controlled actions is possible, this may be performed interactively, for example by receiving voice prompts from the telecommunications network and making selections using the dialling keypad of the mobile telephone.

In the case of telephones which are not equipped for sending text messages, such as many conventional telephones connected by cables to telephone exchanges, control of external devices may nevertheless be provided. It is merely necessary for the conventional telephone to form the control request, which may be no more than a service telephone number to be recognised by the telecommunications network.

Control of external devices may require that the control codes be completely accurate. For example, the external devices may require complex codes or sequences of commands in a predetermined order. These may be predefined and stored within the telecommunications network. Thus, whenever a control request is received, it is ensured that accurate control codes are reliably produced and sent to the external devices so as to ensure substantially completely reliable control of the devices. In general, the control requests are much simpler than the resulting control codes so that the number of errors can be greatly reduced or substantially eliminated. In order to provide a variety or large number of control functions, a corresponding number of control codes are necessary. However, by predefining these and effectively selecting them by much simpler control requests, the processing and memory requirements are located within the telecommunications network so that substantially no processing or memory resources have to be provided within the terminals. Where the terminals are telephones, this reduces the complexity and cost, particularly of mobile telephones where compactness and extended battery life are important requirements.

The invention will be further described, by way of example, with reference to the accompanying drawings, in which:

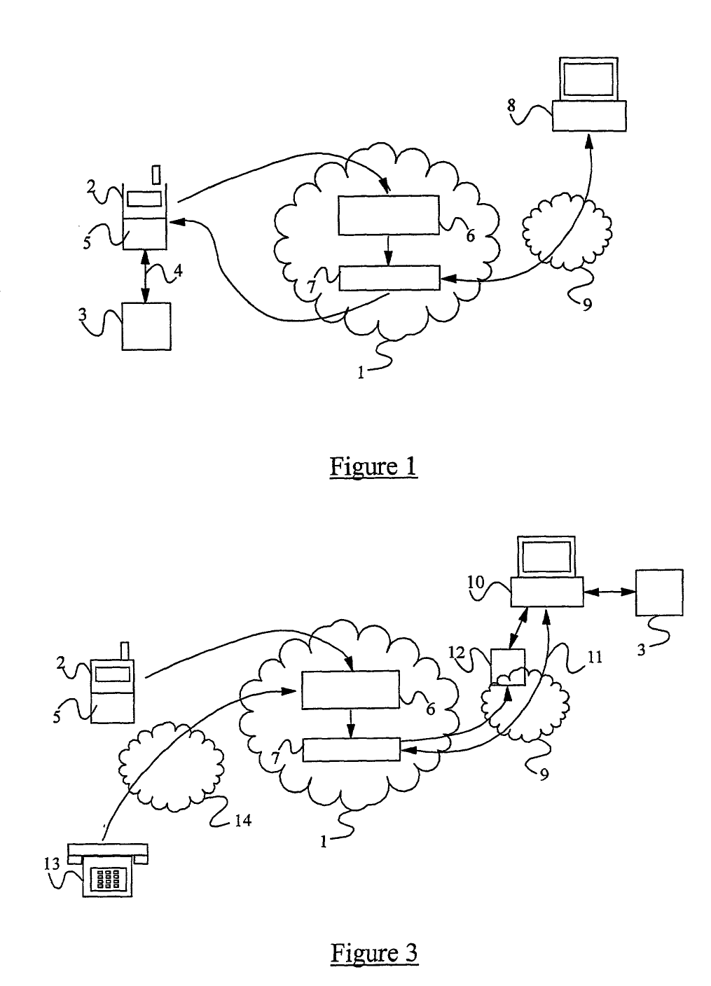

FIG. 1 is a schematic diagram of a first telecommunications system constituting a first embodiment of the invention;

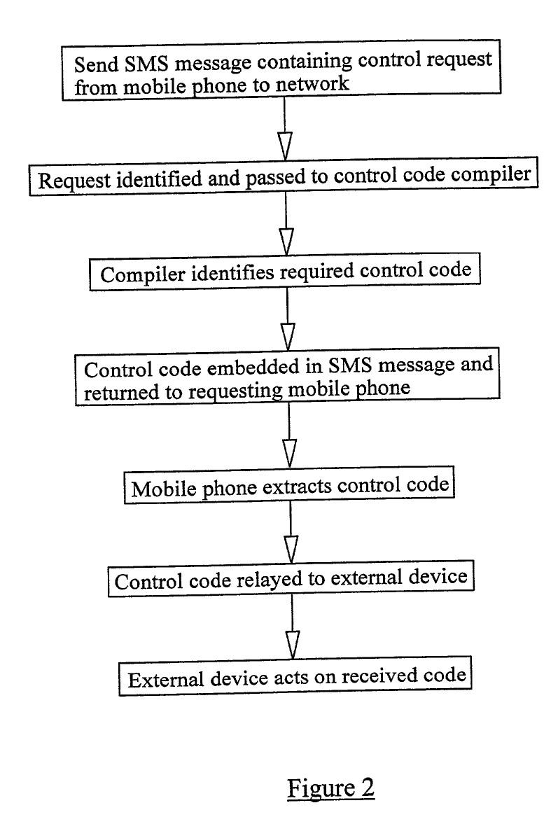

FIG. 2 is a flow diagram illustrating a method of obtaining a control code for controlling an external device; and

FIG. 3 is a schematic diagram of a second telecommunications system constituting a second embodiment of the invention.

FIG. 1 shows a telecommunications network 1 which includes a cellular radio telephone network. A portable cellular telephone 2, illustrated as being of GSM type (the telephone may conform to any other appropriate standard such as UMTS), is associated with an external device 3 which is to be controlled by means of messages from the telephone 2. The telephone 2 and the external device are located adjacent each other and are coupled together, for example by a Bluetooth wireless link 4 (alternatively the telephone 2 and the device 3 may together form a single integrated device).

The telephone 2 has a keypad 5 for dialling and other purposes. In particular, the keypad 5 allows text messages to be composed and transmitted as SMS messages via the cellular radio network (forming part of the network 1) to other terminals which have the capability of receiving and displaying such messages. SMS messages may also be sent to, and terminate at, nodes of the network 1.

In order to control some function or operation of the external device 3, a user enters a control request by means of the keypad 5 of the telephone 2. The telephone 2 transmits the control request to the network 1 in an SMS message. The network includes a command sequence programming interface 6 and a compiler 7 for handling the received SMS message. The interface 6 represents the destination for the SMS message.

The interface 6 recognises the content of the received SMS message as a control request for controlling the external device 3, and passes the request to the compiler 7. The compiler 7 converts the control request into a control code which is suitable, for example without any further processing, for being supplied to the external device 3 in order to perform the desired control operation of the device. For example, the control request may be supplied by the compiler 7 to a previously created database which, as a result, supplies a control code, which may be a single code word or command or may comprise an ordered sequence of code words or commands, to the compiler 7.

In a typical arrangement where a control code is required to produce a predetermined control operation or function of the device 3, the corresponding database entry is required to identify the device and this may be achieved by identifying the A number of the telephone 2 which sent the control request. The entry in the database may, therefore, be in the form of a look-up table associated with a short software routine for producing the desired control code. During the programming phase of the database, the compiler 7 compiles the appropriate control code and checks this for errors. The resulting database entry is then available for subsequent control requests. It is therefore ensured that, whenever the control request is received, the correct control code is reliably produced and sent to the external device.

The control code is embedded in an SMS message and is transmitted by the network 1 to the telephone 2 (typically via an SMS server which is not shown in FIG. 1). Upon receipt of this SMS message, the telephone 2 extracts the control code and supplies this to the external device 3 via the Bluetooth link 4. The receipt of the control code by the device 3 results in the desired function or operation being performed by the device. This process is further illustrated in the flow diagram of FIG. 2.

FIG. 1 also illustrates an arrangement for creating and modifying entries in the network database which maps control requests to corresponding control codes. A personal computer (PC) 8 is connected to the network 1 and, particularly, to the compiler 7 via the Internet 9. The compiler 7 compiles control codes received from the PC 8 and performs error checking to ensure that there are no errors in the compiled control codes. The codes may be supplied by the PC 6 as an e-mail or as an attachment to an e-mail. As an alternative, the codes may be entered using a worldwide web (WWW) page (the compiler 7 is for example a WWW-based command sequence programming interface, for example based on Java or CGI programming languages or texts). Where mobile Internet is available, WAP may be used. This arrangement affords great flexibility to users as they are not restricted to control codes made available by the network operator.

Although FIG. 1 illustrates the external device 3 as being associated with the telephone 2, the external device may be located elsewhere and may be associated with a second mobile telephone. This second telephone may receive control codes sent from the first telephone 2 using SMS messages, or sent from the network in response to a request from the first telephone 2, and relay these to the external device 3. The device 3 does not need to be provided with a telephone per se but instead may make use of a GSM module in order to be able to receive and extract the control codes embedded within SMS messages, in which case the database within the compiler 7 is required to store the B number of the module so as to establish a connection to the module in order to transmit the SMS messages.

In another arrangement, the external device 3 may be associated with other equipment connected to or forming part of the network 1, being remote from the “controlling” telephone 2. Such an arrangement is illustrated in FIG. 3. For example, the external device 3 may be associated with a PC 10 and the control codes may be supplied via e-mail as illustrated at 11 or as a (manually) downloadable web page as illustrated at 12, following a request from the controlling mobile phone 3. If the external device has an SMS interface, the PC 10 may convert the received e-mail into an SMS format for transmission to the external device 3.

The present invention may be employed where the controlling telephone is of a type which is not capable of sending text messages. FIG. 3 illustrates such a telephone 13. A user dials a service telephone number corresponding to the desired control function of the device 3—the connection being made via a PSTN network 14. The network is notified of the call and accesses the database to identify the appropriate control code. The control code is embedded in an e-mail message for sending to the PC 10. It will be appreciated that, where the external device 3 has a GSM module, the control code may be sent to the external device in an SMS message.

In order to select between several control functions or operations of the external device 3, the database used by the compiler 7 may be programmed to provide several options in response to a control request and may interact with the controlling terminal to allow a user to select which function or operation is to be performed. For example, when the A number of the terminal is recognised by the server 11 following the receipt of a control request, a voice-prompting system may be actuated. Pre-recorded or synthesised voice messages are played to the telephone 2, 13, for example asking the user to select from a menu of options by pressing the appropriate key or combination of keys on the keypad of the terminal. The resulting DTMF codes are received by the compiler 7 to select the appropriate menu item. This may be repeated one or more times for nested menus. Once the desired operation or function has been selected, the appropriate control code in the form of the pre-programmed command sequence is embedded in an SMS message or e-mail (or made available via a www page) and transmitted to the external device (via the telephone 2, 13 or PC 10). The correct control code for the desired operation or function is thus supplied to the external device 3, which in turn provides a desired response.

It is thus possible to provide a control arrangement which does not require the storage of control sequences, and hence the provision of sufficient memory capacity, within the telephones 2, 13. Further, it is unnecessary for a user to enter lengthy command sequences manually. Syntactically correct codes are generated so that the complexity and cost of providing syntax checks within the external devices 3 can be greatly simplified or eliminated. Thus, simpler and cheaper microcontrollers may be used in the external devices 3. A user without a GSM telephone or with a GSM telephone without support for SMS messages may still control an external device, for example simply by dialling the appropriate service number as described hereinabove. The external devices to be controlled merely require sufficient intelligence to extract the resulting control codes generated within the telecommunications network from the SMS messages, e-mail, or WWW/WAP page.

This arrangement may be used for many applications, for example where remote control of an external device is required. The following are merely specific examples of the enormous range of possible applications.

Electricity supply meters, for example for homes or offices, may be connected to respective mobile telephone modules having a suitable interface. The electricity supplier may read a meter by telephoning the appropriate predetermined service number. When the telecommunications network receives the telephone call, a control code is sent to a first of the mobile telephone modules and the associated electricity meter to cause the meter reading to be converted into an SMS message and to be transmitted back to the original calling terminal or telephone at the electricity supplier. The electricity supplier may then repeat this operation and the database may step to a next user each time the control request is received. Thus, a large number of electricity meters may be read one at a time in sequence and automatically. Such an arrangement ensures that the electricity supplier cannot cause a serious load on the network by attempting to read large numbers, such as thousands, of meters at substantially the same time.

A house or office heating system may include a room thermostat whose temperature can be set electronically. Thus, a user may dial the appropriate service number in order to commence control of the temperature setting of the thermostat and may then use the telephone keypad to supply DTMF codes in order to set the thermostat temperature to a desired value.

It is possible to provide a control sequence in order to open an electronic lock by using this type of arrangement. For example, the database may be arranged to generate the appropriate control sequence upon receipt of a request from a telephone whose A-number is identified as being authorised to open the lock.

It will be appreciated by the person of skill in the art that various modifications may be made to the above described embodiments without departing from the scope of the present invention. Modifications include:

sending a control code request from a PC, mobile phone/communicator, or PDA via e-mail or the Internet to the network, where the control code is identified and sent to the control device;

requesting a control code from the network using a mobile wireless device, and returning the control code to that device, from where it can be sent to a second mobile device coupled to the external device to be controlled;

providing the compiler 7 outside the telecommunications network, such that a request for a control code is forwarded from the network to the external compiler. The compiler then returns the control code to the network (or possibly sends it directly to the external device);

where a control code is sent from a device as an SMS message, but the external device is capable of receiving only e-mail, an SMS to e-mail conversion may be performed at some point in the transmission path.

1. A method of controlling an external device, comprising the steps of:
sending a control request from a terminal to a telecommunications network;
converting the request into a control code; and
sending the control code from the telecommunications network to the external device.

2. A method according to claim 1, wherein the terminal is a mobile wireless terminal.

3. A method according to claim 2, wherein the control request is sent from the terminal to the telecommunications network using a text messaging service.

4. A method according to claim 1, wherein the control code is sent from the telecommunications network to the external device using a text messaging service.

5. A method according to claim 1, wherein the external device is associated with or forms part of the terminal.

6. A method according to claim 5, wherein the terminal is coupled to the external device via a local wireless link.

7. A method according to claim 5 or 6, wherein the control code is delivered to the external device via said terminal.

8. A method according to claim 1, wherein the external device is remote from the terminal.

9. A method according to claim 8, wherein the external device comprises a telecommunications receiver.

10. A method according to claim 3, wherein the external device comprises a telecommunications receiver and the telecommunications receiver receives a text message containing said control code.

11. A method according to claim 1, in which the step of sending a control request to the telecommunications network comprises calling a service telephone number.

12. A method according to claim 1, in which the telecommunications network interacts with the terminal to select one of a plurality of predetermined control codes for sending to the external device.

13. A method according to 12, in which the interaction is at least partly via a speech channel.

14. A method according to claim 1, in which, in response to receipt of the control code, the external device sends a response comprising at least part of a text message to the telecommunications network.

15. A method according to claim 14, in which the telecommunications network sends at least part of the response as at least part of a further text message to the terminal.

16. A telecommunications network for performing a method as claimed in claim 1.

17. A telecommunications network comprising means for converting a control request from a terminal to a control code and means for sending the control code to an external device for controlling the external device.

18. A network according to claim 17, in which the control request includes an identifier identifying the terminal.

19. A network according to claim 18, in which the sending means is arranged to send the control code to a destination determined by the identifier.

20. A network according to claim 17, in which the control code is predetermined and the sending means is arranged to send the control code in response to receipt of the service number.

21. A network according to claim 17, comprising means for interacting with the terminal to select one of a plurality of predetermined control codes for sending to the external device.

22. A network according to claim 21, in which the interacting means is arranged to interact with the terminal at least partly via a speech channel.

23. A network according to claim 16 or 17, comprising a computer.

24. A program for controlling a computer of a network as claimed in claim 23 to perform a method as claimed in claim 1.

25. A medium containing a program as claimed in claim 24.
